(19) United States
(12) Patent Application Publication
(10) Pub. No.: US 2007/0079778 A1
(43) Pub. Date: Apr. 12, 2007

(54) Cylinder block for integral gas compressor and internal combustion engine

(76) Inventors: Michael Kenneth Atkinson, Midwest City, OK (US); Michael Scott Bowery, Rochester Hills, MI (US); Mark Edward Ford, Oklahoma City, OK (US); Robert Lee Kidd, Oklahoma City, OK (US)

Correspondence Address: MCAFEE & TAFT;TENTH FLOOR, TWO LEADERSHIP SQUARE, 211 NORTH ROBINSON, OKLAHOMA CITY, OK, 73102, US

(21) Appl. No.: 11/247,108

(22) Filed: Oct. 11, 2005

(51) Int. Cl. F04B 17/00; F02B 33/06

(52) U.S. Cl. 123/62; 123/560; 123/198 C; 417/364

(57) ABSTRACT

A cylinder block for an integral gas compressor and internal combustion engine. The cylinder block has a bank of compressor cylinders and a bank of engine cylinders, such as in a V-shaped configuration. Valve train openings are machined into the cylinder block adjacent to the engine cylinders so that engine valve train components, such as push rods, may be disposed therein. No valve train openings are machined into the cylinder block adjacent to the compressor cylinders; the block is left solid. A compressor utilizing the cylinder block is also disclosed.

### BACKGROUND OF THE INVENTION

1. Field of the Invention

The present invention relates to integral gas compressors and internal combustion engines, and more particularly, to a cylinder block for such apparatus which is machined differently on the compressor side and engine side.

2. Description of the Prior Art

Reciprocating gas compressors are well known in the art, and some are suitable for use in handling flammable gases such as natural gas. One type of gas compressor used in these applications is integral with an internal combustion engine.

Previously, the construction of an integral gas compressor and internal combustion engine included removing some of the engine components and replacing them with compressor components. For example, U.S. Pat. No. 2,133,769 to Jones discloses an engine-compressor unit with one side of a V-shaped engine, in this case a Ford V-8, being converted to an air compressor. In this apparatus, the engine head on one bank of cylinders is removed, along with the pistons and engine intake and exhaust valves, valve push rods and valve springs. A compressor head is installed on that bank of cylinders of the engine in place of the engine head, and compressor intake and exhaust valves are installed in the compressor head. The Jones apparatus is made from a flathead engine in which the valves are mounted in the engine block below the engine head, and the compressor head covers the existing openings through which the engine valve originally extended. In Jones, apparatus is designed for use with atmospheric air only, and does not address the problems involved with handling gases with inlet pressures above atmospheric pressure or gases which are flammable, such as natural gas.

An integral gas compressor and internal combustion engine designed for flammable gases and above atmospheric inlet pressures is disclosed in U.S. Pat. Nos. 4,961,891; 5,189,905; 5,203,680; and 5,267,843 to Waldrop, assigned to the assignee of the present invention. This compressor is shown constructed using a converted V-8 engine. The compressor head on this apparatus manifolds a plurality of inlet valves together. The engine for this compressor is a V-8 engine of a more modem overhead-valve type than the flathead of Jones. In this overhead-valve engine, the cylinder block, also sometimes referred to as the engine block, has a longitudinally extending port therethrough with a plurality of openings intersecting the port substantially perpendicular thereto. Engine valves are mounted on the engine head under a valve cover, and valve push rods are disposed in the openings in the cylinder block to engage valve rocker arms which in turn actuate the valves. The longitudinal port, also referred to as an oil gallery, provides a lubrication path from the engine oil pump to the valve push rods. When converting one side of an existing engine to a compressor, opposite ends of the longitudinal port and all of the intersecting openings have to be plugged. This not only adds to the cost of building the compressor but can also be a source of oil leaks if any of the plugs do not seal properly. Therefore, there is a need for a cylinder block where it is not necessary to plug ports or openings.

The present invention solves this problem by providing a cylinder block which is manufactured solely for use in an integral gas compressor and internal combustion engine. In this cylinder block, the compressor side is left as a solid casting and no ports or openings are machined. Only the engine side is machined to include the port and openings. Thus, the cost of plugging is eliminated, and there is no possibility of oil leaks.

### SUMMARY OF THE INVENTION

The present invention includes a cylinder block specifically designed for use in an integral gas compressor and internal combustion engine. The block comprises an engine portion defining an engine cylinder therein with a valve train opening defined adjacent to the engine cylinder and also comprises a compressor portion defining a compressor cylinder therein wherein the compressor portion has no valve train opening. The valve train opening in the engine portion is adapted for receiving an engine valve train component therein.

The compressor cylinder and engine cylinder preferably form a V-shaped configuration. In one embodiment, the cylinder block has a V-8 configuration wherein the engine cylinder is one of four engine cylinders, the compressor cylinder is one of four compressor cylinders and the valve train opening is one of a plurality of valve train openings adjacent to the engine cylinders.

Stated in another way, the cylinder block of the present invention comprises a first section with a plurality of cylinders defined therein and having a plurality of bosses integrally formed thereon and a second section with a plurality of cylinders defined therein and having a plurality of bosses integrally formed thereon. The bosses on one of the first and second sections are solid, and the bosses on the other of the first and second sections define valve train openings therein for receiving a portion of an engine valve train therein. Each of the cylinders on the one section are adapted for receiving a compressor piston therein, and each of the cylinders on the other section are adapted for receiving an engine piston therein. Preferably, the first and second sections form a V-shaped configuration, such as a V-8 configuration with four cylinders each.

The invention may also be described as an integral gas compressor and internal combustion engine apparatus comprising a cylinder block defining a set of compressor cylinders and a set of engine cylinders therein and further defining valve train openings adjacent to the set of engine cylinders only, a crankshaft rotatably disposed in the cylinder block, a compressor piston disposed in each of the compressor cylinders, an engine piston disposed in each of the engine cylinders, a connecting rod connecting each of the compressor and engine pistons to the crankshaft, a compressor head with compressor valves therein adjacent to the compressor cylinders, an engine head adapted for receiving engine valves therein adjacent to the engine cylinders, a cam rotatably disposed in the cylinder block, and an engine valve train including engine valves and engaging the cam, a portion of the engine valve train extending through the valve train openings.

Preferably, the portion of the valve train extending though the valve train openings comprises a plurality of valve push rods.

The cylinder block in the compressor further defines an oil gallery connectable to an engine oil pump and in communication with the valve train openings.

In the preferred embodiment, the cylinder block has a V-shaped configuration having a pair of banks, wherein the compressor cylinders are defined in one bank and the engine cylinders are defined in the other bank. The cylinder block may have a V-8 configuration having four compressor cylinders and four engine cylinders. The valve train openings are completely defined in the bank defining the engine cylinders.

Numerous objects and advantages of the invention will become apparent as the following detailed description of the preferred embodiment is read in conjunction with the drawings illustrating such embodiment.

### BRIEF DESCRIPTION OF THE DRAWINGS

FIG. 1 generally shows a compressor package of the type which utilizes the cylinder block for an integral gas compressor and internal combustion engine of the present invention.

FIG. 2 is a plan view of the compressor package of FIG. 1.

FIG. 3 is an end view of an integral gas compressor and internal combustion engine showing the cylinder block of the present invention.

FIG. 4 is a perspective view of the cylinder block.

FIG. 5 is a vertical cross section taken along lines 5-5 in FIG. 4.

FIG. 6 is a horizontal cross section taken along lines 6-6 in FIG. 5.

### DETAILED DESCRIPTION OF THE PREFERRED EMBODIMENT

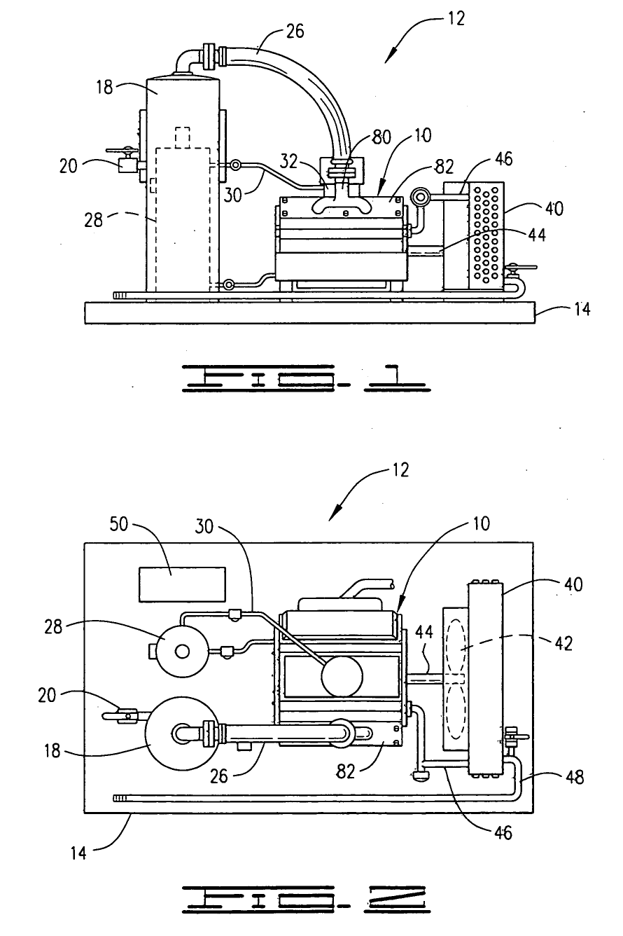

Referring now to the drawings, and more particularly to FIG. 1, an integral gas compressor and internal combustion engine which incorporates the cylinder block of the present invention is shown and generally designated by the numeral 10. Compressor 10 is shown as a portion of a compressor package 12. Integral gas compressor and internal combustion engine 10 will also be referred to herein as simply compressor 10.

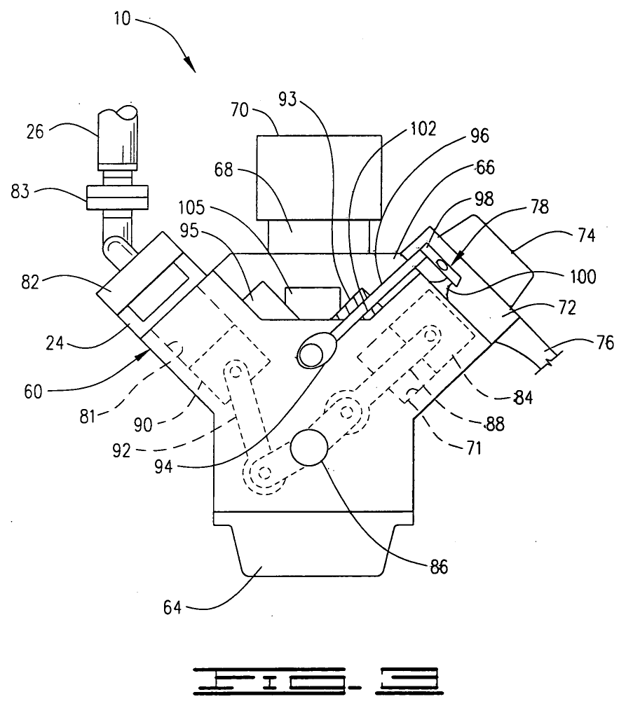

Compressor package 12 as illustrated is of a type particularly well adapted for use in recovering natural gas from a well, but may be used for other flammable gases or gases with elevated inlet pressures. The invention is not intended to be limited to the illustrated compressor package 12. FIGS. 1 and 2 have been greatly simplified to eliminate much of the piping and wiring associated with package 12. The omitted items are known in the art and are not necessary for an understanding of the invention.

In a typical package 12, such as that shown in FIGS. 1 and 2, compressor 10 is mounted on a skid or baseplate 14. An inlet tank and liquid separator 18 is also attached to skid 14. A valve 20 is in communication with tank 18 and is adapted for connection to the source of the gas to be compressed. In one embodiment, this gas would be natural gas from a wellhead (not shown), but compressor 10 and package 12 can be adapted to virtually any gas, and the invention is not intended to be limited to any particular application.

The top of tank 18 is connected to a compressor inlet manifold 82 mounted on a compressor head 24 on compressor 10 by a line 26. That is, line 26 is an inlet or suction line for compressor 10.

Positioned adjacent to tank 18 is a fuel vessel 28 which is adapted for connection to a fuel source, such as the natural gas wellhead. A line 30 connects fuel vessel 28 to carburetor 32 on the engine portion of compressor 10.

An aftercooler 40 is mounted on skid 14 and used to cool gas discharged from compressor 10. Aftercooler 40 is shown as a finned tube type with a cooling fan 42 associated therewith. Fan 42 may be driven by a drive shaft 44 extending from compressor 10. Aftercooler 40 may include an engine jacket water-cooling section to cool the engine and compressor sections of compressor 10.

A discharge line 46 connects the outlet of compressor 10 with aftercooler 40. An aftercooler outlet line 48 extends from aftercooler 40.

An electrical control panel 50 for controlling the apparatus may be positioned on skid 14. Control panel 50 is of a kind generally known in the art, and the connections thereto are omitted for clarity.

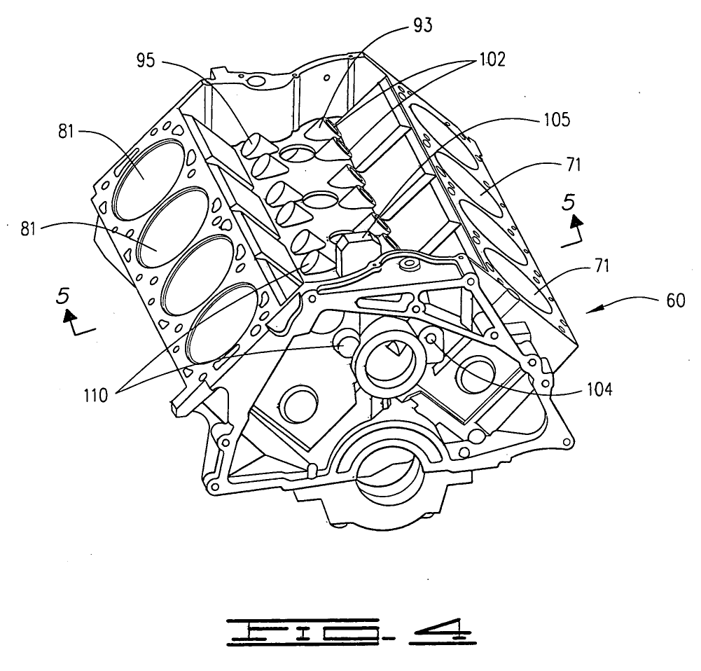

Compressor 10 is constructed using the general layout of a known internal combustion engine, such as, but not limited to, a 460 cubic inch Ford V-8 engine. The general V-shaped configuration of compressor 10 is shown in FIG. 3. Compressor 10 comprises a new cylinder block 60 specifically designed to be used as a compressor on one side or bank and as an engine on the other side or bank. As will be further discussed herein, the present invention does not use the original engine cylinder block as prior art compressors do.

Below cylinder block 60 is an oil pan 64. At the upper end of cylinder block 60 is an engine intake manifold 66. Oil pan 64 and engine intake manifold 66 are standard components of the original Ford or other engine. A known carburetor 68 and air cleaner 70 are mounted on engine intake manifold 66.

Connected to cylinder block 60 on the right bank of cylinders 71, as viewed in FIG. 3, is a standard engine head 72 with a valve cover 74 thereon. An exhaust manifold 76 carries away the exhaust gases of the engine. This right side of compressor 10 remains basically a standard engine and includes valve train 78, as will be further discussed herein, and other engine components which are not illustrated, such as spark plugs, wiring, etc.

The left side of compressor 10, as viewed in FIG. 3, is used for gas compression. Compressor head 24 is attached to cylinder block 60 on the left bank of cylinders 81. Connected to compressor head 24 is compressor inlet manifold 82. Attached to compressor inlet manifold 82 is a flange 83 to which inlet line 26 is connected. Compressor head 24, compressor inlet manifold 82 and flange 83 are of the kind described in the above-referenced patents to Waldrop.

Standard engine pistons 84 are reciprocably disposed in the cylinders 71 on the right bank of cylinder block 60. Thus, cylinders 71 may be described as engine cylinders 71. The engine pistons are connected to crankshaft 86 by connecting rods 88. Again, engine pistons 84, crankshaft 86 and connecting rods 88 are the original components of the engine on which compressor 10 is based.

A plurality of compressor pistons 90 are reciprocably disposed in cylinders 81 in the left bank of cylinder block 60. Thus, cylinders 81 may be described as compressor cylinders 81. Each compressor piston 90 is connected to crankshaft 86 by additional connecting rods 92. Compressor pistons 90 are preferably specifically designed for gas compression, but connecting rods 92 may be the same as connecting rods 88 on the engine side of compressor 10.

A plurality of bosses 93 and 95 are integrally cast into cylinder block 60 adjacent to engine cylinders 71 and compressor cylinders 81, respectively.

Valve train 78 of the engine side of compressor 10 includes a rotating cam 94 which engages a plurality of push rods 96. Push rods 96 in turn engage corresponding valve rocker arms 98 which actuate engine valves 100 in each cylinder in a manner known in the art. Valve springs are not shown.

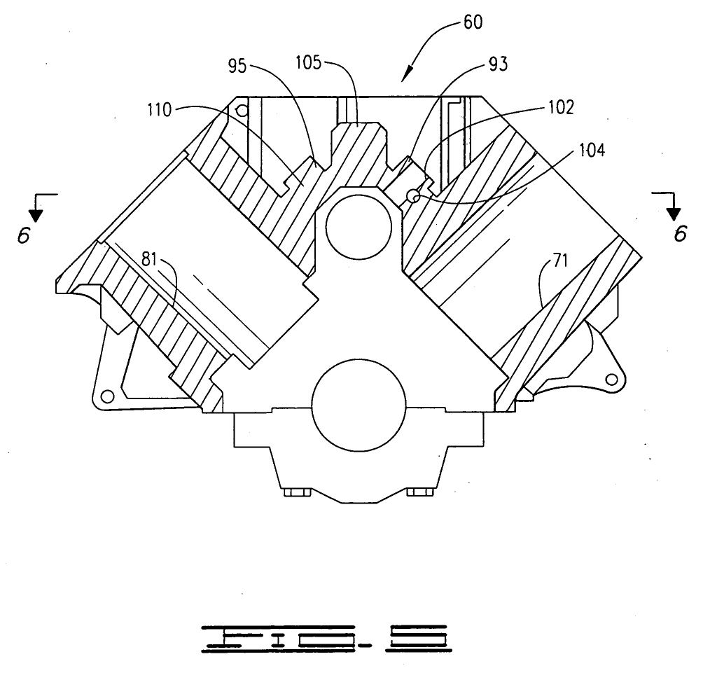

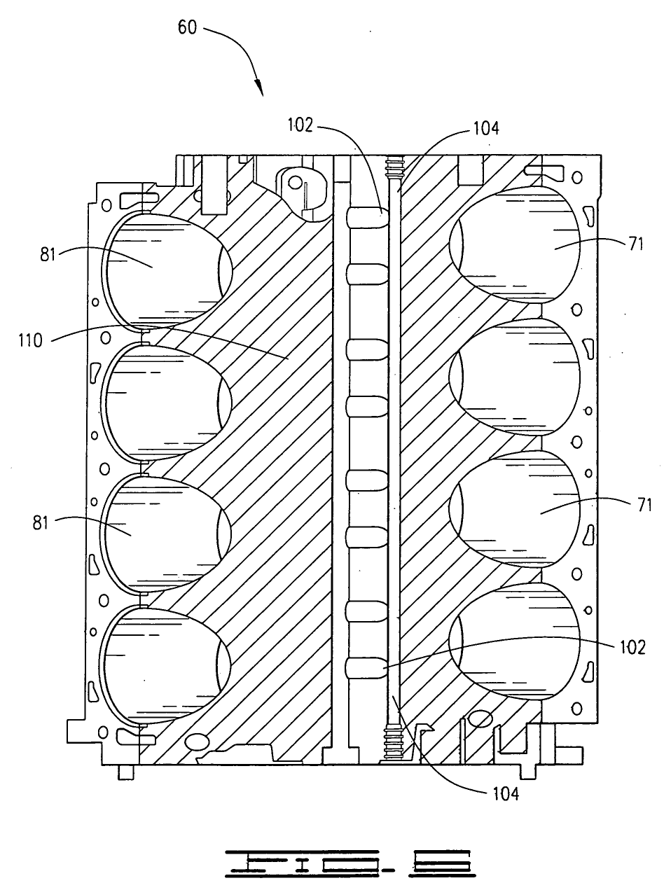

Referring to FIGS. 3-6, each push rod 96 is movably disposed in a corresponding push rod opening 102 machined in each boss 93 of cylinder block 60. A longitudinally extending oil port or gallery 104 intersects openings 102 and thus is in communication therewith. Engine lubricating oil is pumped by the engine oil pump (not shown) to port 104 and thus to openings 102 in a manner known in the art.

In previously known integral gas compressor and internal combustion apparatus made from previously existing engines, there are identical openings 102 in bosses 95 and a port 104 on the compressor side, all of the ports and openings being in communication with one another by crossover passages (not shown) in an enlarged section 105. Because there is no valve train, and thus no push rods, on the compressor side, it will be seen by those skilled in the art that the port and openings in previously-existing engines will result in an open path for oil to flow out onto the cylinder block if the port and openings are not closed. Not only does this cause a loss of oil pressure for the engine, the presence of oil on the compressor side is undesirable. Therefore, in previous apparatus of this type, port 104 and openings 102 have been plugged on the compressor side. This adds to the material and labor costs of the equipment and also requires leak testing.

Unlike the prior art, cylinder block 60 of the present invention is only machined for the engine valve train on the engine side of the block. That is, bosses 95 and enlarged section 105 are left solid and unmachined. The compressor side of cylinder block 60, as seen on the left sides of FIGS. 3-6, is not machined at all. That is, on cylinder block 60, there is a solid portion 110, and the block is designed to fully isolate oil in the engine side from the compressor side. Thus, there is no need to plug any port or openings to prevent the problems associated with prior compressors made from existing engine blocks.

While cylinder block 60 has been shown in the drawings with the engine side or section on the right and the compressor side or section on the left, these could be reversed by reversing the machining. That is, compressor 10 could be made with the engine side or section on the left and the compressor side or section on the right.

It will be seen, therefore, that the cylinder block for integral gas compressor and internal combustion engine of the present invention is well adapted to carry out the ends and advantages mentioned as well as those inherent therein. While a presently preferred embodiment of the apparatus has been shown for the purposes of this disclosure, numerous changes in the arrangement and construction of the parts may be made by those skilled in the art. All such changes are encompassed within the scope and spirit of the appended claims.

What is claimed is:

1. an integral gas compressor and internal combustion engine apparatus comprising:
a cylinder block defining a set of compressor cylinders and a set of engine cylinders therein, and further defining valve train openings adjacent to the set of engine cylinders only;
a crankshaft rotatably disposed in the cylinder block;
a compressor piston disposed in each of the compressor cylinders;
an engine piston disposed in each of the engine cylinders;
a connecting rod connecting each of the compressor and engine pistons to the crankshaft;
a compressor head with compressor valves therein adjacent to the compressor cylinders;
an engine head adapted for receiving engine valves therein adjacent to the engine cylinders;
a cam rotatably disposed in the cylinder block; and
an engine valve train including engine valves and engaging the cam, a portion of the engine valve train extending through the valve train openings.

2. The apparatus of claim 1 wherein the portion of the valve train extending through the valve train openings comprises a plurality of valve push rods.

3. The apparatus of claim 1 wherein the cylinder block further defines an oil gallery connectable to an engine oil pump and in communication with the valve train openings.

4. The apparatus of claim 3 wherein the valve train openings are adapted to receive valve push rods therethrough.

5. The apparatus of claim 1 wherein the cylinder block has a V-shaped configuration having a pair of banks, wherein the compressor cylinders are defined in one bank and the engine cylinders are defined in the other bank.

6. The apparatus of claim 5 wherein the cylinder block has a V-8 configuration having four compressor cylinders and four engine cylinders.

7. The apparatus of claim 5 wherein the valve train openings are completely defined in the bank defining the engine cylinders.

8. A cylinder block for an integral gas compressor and internal combustion engine, the block comprising:
an engine portion defining an engine cylinder therein and further defining a valve train opening adjacent to the engine cylinder and adapted for receiving an engine valve train component therein; and
a compressor portion defining a compressor cylinder therein wherein the compressor portion has no valve train opening.

9. The cylinder block of claim 8 wherein the compressor cylinder and engine cylinder form a V-shaped configuration.

10. The cylinder block of claim 9 wherein:
the cylinder block has a V-8 configuration;
the engine cylinder is one of four engine cylinders;
the compressor cylinder is one of four compressor cylinders; and
the valve train opening is one of a plurality of valve train openings adjacent to the engine cylinders.

11. The cylinder block of claim 8 wherein the valve train opening is adapted to receive an engine valve push rod therethrough.

12. A cylinder block for an integral gas compressor and internal combustion engine, the block comprising:
a first section with a plurality of cylinders defined therein and having a plurality of bosses integrally formed thereon; and
a second section with a plurality of cylinders defined therein and having a plurality of bosses integrally formed thereon;
wherein, the bosses on one of the first and second sections are solid, and the bosses on the other of the first and second sections define valve train openings therein for receiving a portion of an engine valve train.

13. The cylinder block of claim 12 wherein:
each of the cylinders on the one section are adapted for receiving a compressor piston therein; and
each of the cylinders on the other section are adapted for receiving an engine piston therein.

14. The cylinder block of claim 12 wherein the first and second sections form a V-shaped configuration.

15. The cylinder block of claim 14 wherein the first and second sections form a V-8 configuration with four cylinders each.

16. The cylinder block of claim 12 wherein the valve train openings are adapted for receiving a valve push rod therethrough.

17. The cylinder block of claim 16 further defining an oil gallery intersecting each of the valve train openings.
